(19) United States
(12) Patent Application Publication
(10) Pub. No.: US 2012/0146419 A1
(43) Pub. Date: Jun. 14, 2012

(54) POWER SUPPLY SYSTEM INCORPORATING UPS

(75) Inventor: CHIH-CHUNG SHIH, Tu-Cheng (TW)

(73) Assignee: HON HAI PRECISION INDUSTRY CO., LTD., Tu-Cheng (TW)

(21) Appl. No.: 13/111,976

(22) Filed: May 20, 2011

(30) Foreign Application Priority Data
Dec. 14, 2010 (TW) 99143660

(51) Int. Cl. H02J 9/06

(52) U.S. Cl. 307/66

(57) ABSTRACT

An exemplary power supply system includes a main power supply, an uninterruptible power supply (UPS) connected to the main power supply, a control unit connected to the UPS, and a server unit connected to the UPS through a power distribution unit. The UPS includes a rectifier connected to the main power supply, a power storage module connected to the rectifier, a switch connected to the rectifier, and an inverter connected to the rectifier and in parallel connection with the switch. The control unit includes a sensor and a control element connecting the sensor with the switch. The sensor can detect an environment around the server unit to produce different signals to the control element, to thereby control the UPS to output DC or AC by turning the switch on or off.

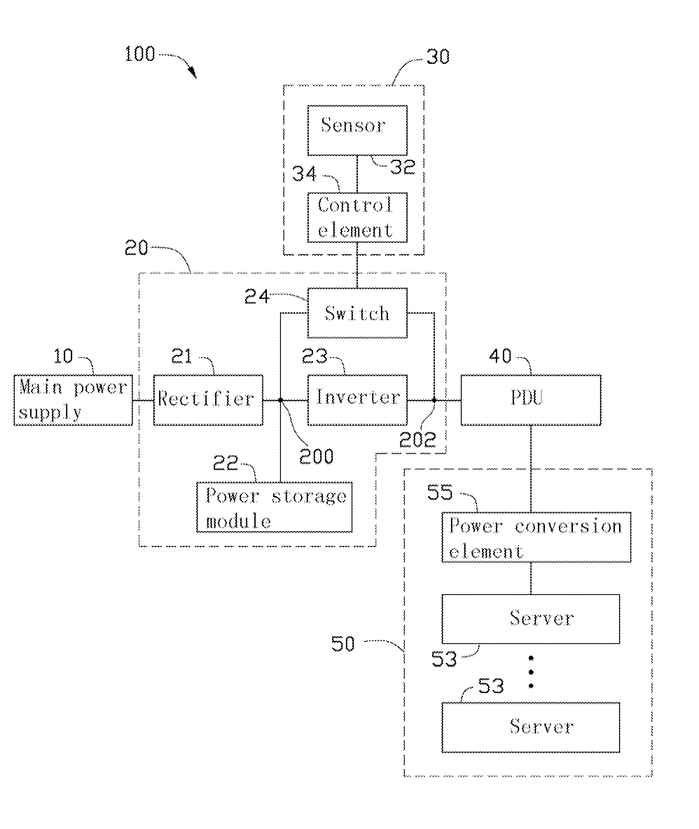

### BACKGROUND

1. Technical Field

The present disclosure relates to power supply systems, and particularly, to a power supply system incorporating a UPS (uninterruptible power supply).

2. Description of Related Art

Servers are typically used for storing and processing data. In order to prevent data loss when a main power supply connected to the servers has an outage, generally, a UPS is provided for maintaining continuous operation of the servers. A typical UPS includes a rectifier, a battery and an inverter. When the main power supply is in operation, the rectifier converts AC (alternating current) from the main power supply to DC (direct current). The battery receives the DC and is charged. When the main power supply has an outage, the battery releases the stored DC power to the inverter. The inverter converts the DC from the battery to AC, and thereby is able to electrify the servers. However, each conversion between AC and DC causes energy loss. This means that the power consumption of the battery is somewhat high, and the power transferred from the UPS to the servers is attenuated.

In order to reduce conversion loss in the power transferring processes, the typical UPS may be rebuilt to directly output HVDC (high voltage direct current) for the servers. Nevertheless, HVDC is dangerous to people who are close to the UPS or the servers. The rebuilt UPS does not necessarily meet electrical safety standards or criteria.

What is needed, therefore, is a power supply system which can overcome the limitations described above.

### BRIEF DESCRIPTION OF THE DRAWINGS

Many aspects of the present disclosure can be better understood with reference to the following drawing. In the drawing, the emphasis is placed upon clearly illustrating the principles of the present disclosure. Moreover, in the drawing, like reference numerals designate corresponding parts throughout.

The sole drawing is a block diagram of a power supply system of an embodiment of the present disclosure.

### DETAILED DESCRIPTION

Referring to the drawing, a power supply system 100 in accordance with an embodiment of the present disclosure is shown. The power supply system 100 includes a main power supply 10, a UPS (uninterruptible power supply) 20 connected to the main power supply 10, a control unit 30 connected to the UPS 20, a server unit 50, and a PDU (power distribution unit) 40 connecting the UPS 20 with the server unit 50.

The main power supply 10 is typically a mains supply which provides AC (alternating current). The UPS 20 includes a rectifier 21, a power storage module 22, a switch 24, and an inverter 23. The rectifier 21, the power storage module 22, the switch 24 and the inverter 23 are all connected to a first node 200. The rectifier 21 is coupled with the main power supply 10 to convert the AC from the main power supply 10 to DC (direct current). The power storage module 22 is connected to the rectifier 21 through the first node 200. The power storage module 22 is charged by the DC converted by the rectifier 21 when the main power supply 10 is in operation. The power storage module 22 also acts as a power source to output stored power in the form of DC, in particular HVDC, when the main power supply 10 has an outage. The inverter 23 is connected to the rectifier 21 and the power storage module 22 through the first node 200. The inverter 23 can convert the DC delivered from the power storage module 22 to AC. Such converted AC from the inverter 23 can be directly used for powering general electronic devices, since the converted AC has the same electrical characteristic as that provided by the main power supply 10. The switch 24 is connected to the rectifier 21 and the inverter 23 through the first node 200. The switch 24 is also connected to the rectifier 23 at a second node 202 to form a parallel connection with the inverter 23. The switch 24 is switchable by control of the control unit 30 between an on status and an off status. When the switch 24 is turned on, the inverter 23 is electrically shorted so that the DC provided by the power storage module 22 directly flows through the switch 24 to the PDU 40. When the switch 24 is turned off, the DC provided by the power storage module 22 flows through the inverter 23 to be converted to AC, which is then output to the PDU 40.

The control unit 30 includes a control element 34 coupled with the switch 24, and a sensor 32 connected to the control element 34. The sensor 32 can detect an environment around the server unit 50, and produce corresponding signals. The sensor 32 may be a vibration sensor, a sound sensor, an infrared sensor or the like. The control element 34 receives the signals of the sensor 32 to control the status of the switch 24. For example, when a person is close to the server unit 50, the sensor 32 detects the presence of the person to produce a first signal and send the first signal to the control element 34, and the control element 34 controls the switch 24 to open, whereby the DC supplied from the power storage module 22 is converted by the inverter 23 to AC, which is then delivered to the PDU 40. When the sensor 32 detects no person close to the server unit 50, the sensor 32 produces a second signal and sends the second signal to the control element 34 to control the switch 34 to close, thereby allowing the DC supplied from the power storage module 22 to directly flow to the PDU 40 through the switch 24.

Therefore, in general operation, the UPS 20 can directly output DC to the server unit 50 to obtain a high energy transferring efficiency by reducing DC/AC and AC/DC conversion loss. As soon as the sensor 32 detects the presence of a person close to the server unit 50, the UPS 20 is switched to output the AC for the server unit 50, thereby protecting the person from DC directly output from the power storage module 22. Since in general the server unit 50 does not need to be manually operated by an operator, the UPS 20 can power the server unit 50 with the DC at most times. Thus, not only is efficient utilization of power of the UPS 20 achieved, but also the safety of any person close to the server unit 50 is enhanced.

The PDU 40 is connected to the switch 24 and the inverter 23 through the second node 202. The PDU 40 is used to distribute and manage power for the server unit 50. The server unit 50 includes a plurality of servers 53 and a power conversion element 55 connecting the servers 53 with the PDU 40. The power conversion element 55 can rectify and lower the AC delivered from the inverter 23 to DC having a predetermined value, to thereby power the servers 53. The power conversion element 55 can also lower the DC directly delivered from the power storage module 22 through the switch 24 to DC having the predetermined value, to thereby power the servers 53.

It is believed that the present embodiments will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A power supply system comprising:
an uninterruptible power supply (UPS) comprising a rectifier for connecting with a main power supply, a power storage module, and an inverter and a switch connected to the power storage module in parallel;
a control unit connected to the switch; and
a server unitnnected to the control unit;
wherein the control unit is operable to detect an environment around the server unit;
when the control unit detects there is no person adjacent to the server unit, the switch is closed to transfer direct current provided from the power storage module to the server unit; and
when the control unit detects there is a person adjacent to the server unit, the switch is opened so that direct current provided by the power storage unit is converted to alternating current by the inverter, and the alternating current is provided to the server unit.

2. The power supply system of claim 1, wherein the switch and the inverter are connected to each other at a first node and a second node.

3. The power supply system of claim 2, wherein the rectifier is connected between the first node and the main power supply.

4. The power supply system of claim 2, wherein the power storage module is connected to the first node.

5. The power supply system of claim 2 further comprising a power distribution unit connected between the second node and the server unit.

6. The power supply system of claim 5, wherein the server unit comprises a plurality of servers and a power conversion element connecting the servers with the power distribution unit.

7. The power supply system of claim 1, wherein the control unit comprises a sensor and a control element connecting the sensor with the switch.

8. The power supply system of claim 7, wherein the sensor is selected from a vibration sensor, an infrared sensor, and a sound sensor.

9. The power supply system of claim 1, wherein the main supply unit is a mains supply.

10. A power supply system comprising:
a main power supply;
an uninterruptible power supply (UPS) connected to the main power supply, the UPS comprising:
a rectifier;
a power storage module connected to the rectifier;
a switch connected to the rectifier and the power storage module; and
an inverter connected to the rectifier and the power storage module, the inverter and the switch being connected in parallel with the power storage module;
a control unit comprising a sensor and a control element connecting the sensor with the switch; and
a server unit connected to the UPS;
wherein when the sensor detects the presence of a person close to the server unit, the control element turns the switch off to enable direct current provided by the power storage module to be converted by the inverter to alternating current, which is delivered to the server unit; and
wherein when the sensor detects no presence of a person close to the server unit, the control element turns the switch on to enable direct current provided by the power storage module to be directly delivered to the server unit through the switch.

11. The power supply system of claim 10, wherein the rectifier, the power storage module, the switch and the inverter and all connected to a first node.

12. The power supply system of claim 11, wherein the rectifier is connected between the main power supply and the first node.

13. The power supply system of claim 11, wherein the switch and the inverter are further connected to a second node.

14. The power supply system of claim 13, further comprising a power distribution unit connected to the switch and the inverter through the second node.

15. The power supply system of claim 14, wherein the power distribution unit is connected to the server unit.

16. The power supply system of claim 15, wherein the server unit comprises a plurality of servers and a power conversion element connecting the servers with the power distribution unit.

17. The power supply system of claim 10, wherein the sensor is one of a sound sensor, an infrared sensor and a vibration sensor.

18. The power supply system of claim 10, wherein the main power supply is a mains supply providing alternating current.

19. A power supply system comprising:
an uninterruptible power supply (UPS) comprising a rectifier adapted for connecting with a main power supply, a power storage module, and an inverter and a switch connected to the rectifier in parallel and connected to the power storage module in parallel;
a control unit connected to the switch; and
a server unit coupled to the control unit;
wherein the control unit is operable to detect an environment around the server unit;
when the control unit detects there is no person adjacent to the server unit, the control unit controls the switch to be closed such that direct current provided from the power storage module is transferred to the server unit via the switch; and
when the control unit detects there is a person adjacent to the server unit, the control unit controls the switch to be open so that direct current provided by the power storage unit is converted to alternating current by the inverter and the alternating current is provided to the server unit.
